(19) United States
(12) Patent Application Publication
(10) Pub. No.: US 2011/0087922 A1
(43) Pub. Date: Apr. 14, 2011

(54) TEST METHOD AND TOOL FOR MASTER-SLAVE SYSTEMS ON MULTICORE PROCESSORS

(75) Inventors: JENQ KUEN LEE, HSINCHU (TW); SHOU WEI CHANG, KAOHSIUNG CITY (TW)

(73) Assignee: NATIONAL TSING HUA UNIVERSITY, HSINCHU (TW)

(21) Appl. No.: 12/576,678

(22) Filed: Oct. 9, 2009

(51) Int. Cl. G06F 11/07

(52) U.S. Cl. 714/26; 714/32; 714/E11.024; 714/E11.029

(57) ABSTRACT

A test method for a master-slave concurrent system running on a multicore processor includes the steps of establishing a PFA, otherwise called probabilistic finite automata, or probabilistic finite state machine, for a given regular expression; generating test patterns by running the PFA; splitting and merging the test patterns to generate an interleaved test pattern; and performing test on the master-slave system according to the interleaved test pattern. In an embodiment, the method further includes a step of debugging failures of the multicore processor during testing.

### BACKGROUND OF THE INVENTION

(A) Field of the Invention

The present invention relates to a test method and a test tool for a multicore processor.

(B) Description of the Related Art

Embedded multicore processors have been widely adopted in the consumer electronics market to meet the ever-increasing performance requirements of mobile computing and multimedia applications. Such architecture is conventionally composed of clusters of processing cores connected by on-chip communication networks, high-bandwidth memory subsystems, and integrated peripheral interfaces. One of the popular programming models of the embedded multicore systems is the master-slave model. The master-slave model is a simple model for concurrent processing and is widely used in asymmetric multicore processors to utilize distributed computing resources more effectively. In the master-slave model, a cluster of processing cores is classified into two categories, master and slave, where the executable processes of a system on a slave processing core are controlled by the remote processes of a system on a master processing core.

Although the master-slave model is a simple model, the embedded multicore system that adopts it still may crash due to unreliable software. Two factors that can cause such failures of embedded multicore systems are the crash of the slave system under heavy loads, and synchronization anomalies, such as deadlock and starvation, which may occur in concurrent programs. The common functional testing methodologies are not capable of detecting these software faults during the development stage.

### SUMMARY OF THE INVENTION

The test method and software tool are designed to execute a stress test on a runtime system running on a specialized processing unit of embedded multicore processors. The test runs on the master system to issue a large number of commands for stress testing the runtime behavior of the slave system. This invention can avoid potential failures such as slave system crashes and software deadlock/livelock in the master-slave system.

According to an aspect of the present invention, a test method for a master-slave concurrent system running on a multicore processor includes the steps of establishing a PFA, otherwise called probabilistic finite automata, or probabilistic finite state machine, for a given regular expression; generating test patterns by running a PFA; splitting and merging the test patterns to generate an interleaved test pattern; and performing testing in a master-slave system according to the interleaved test pattern. In an embodiment, the method further includes a step of debugging failures of a master-slave system during testing.

According to another aspect of the present invention, a test tool for a master-slave concurrent system running on a multicore processor includes a pattern generator, a pattern merger and a bug detector. The pattern generator is configured to generate test patterns by running a PFA for a given regular expression. The pattern merger is configured to split and merge the test patterns to generate an interleaved test pattern. The bug detector is configured to debug failures of a master-slave system while performing test on a master-slave system according to the interleaved test pattern.

### BRIEF DESCRIPTION OF THE DRAWINGS

The objectives and advantages of the present invention will become apparent upon reading the following description and upon reference to the accompanying drawings in which:

FIG. 1 illustrates one example of a PFA in accordance with the invention;

FIG. 2 illustrates a test tool for a master-slave concurrent system running on a multicore processor in accordance with an embodiment of the present invention;

FIG. 3 illustrates a PFA with slave system services in accordance with an embodiment of the present invention;

FIG. 4 illustrates a flow chart of a test method for a master-slave concurrent system running on a multicore processor in accordance with the present invention; and

FIG. 5 illustrates a test flow running on the slave system in accordance with the present invention.

### DETAILED DESCRIPTION OF THE INVENTION

Probabilistic finite automata (PFA) or named probabilistic finite state machine are used in various domains such as mutation testing, machine translation, and bioinformatics. A PFA is a promising model to specify systems that introduces probabilistic choice to deal with possible actions. In this invention, a simplified definition of the PFA without initial state probabilities or final state probabilities is utilized. A PFA is used to generate test patterns according to probability distributions. The PFA is defined as a finite-state automaton with only state transition probabilities and a state in the PFA is modeled as a service of a slave system

A PFA is defined as a sextuple (Q, Σ, δ, q₀, F, P), where:

Q is a finite set of states;

Σ is a finite alphabet;

δ⊂Q×E×Q is the state transition relation;

q₀εQ is the initial state;

F⊂Q is the set of final states;

P: δ→R⁺, where R⁺ is the set of positive real numbers, is the transition probability function such that:

$${\sum }_{∀ a ∈ \sum , {q}^{′} ∈ Q} P ( q , a , {q}^{′} ) = 1 , where q ∈ Q$$

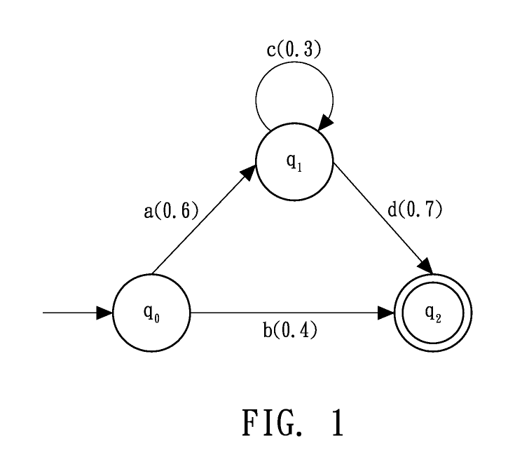

FIG. 1 illustrates one example of a PFA graph with three states, Q={q₀, q₁, q₂}; only one initial state, q₀; a four-symbol alphabet, {a, b, c, d}; and four state transition probabilities, {P(q₀, a, q₁)=0.6, P(q₀, b, q₂)=0.4, P(q₁, c, q₁)=0.3, (q₁, d, q₂)=0.7}. Each transition has an associated probability that is a positive real number strictly between 0 and 1. The sum of the probabilities of all possible transitions for a given state is equal to 1. The regular expression describing the language recognized by this simple PFA is (ac*d)|b.

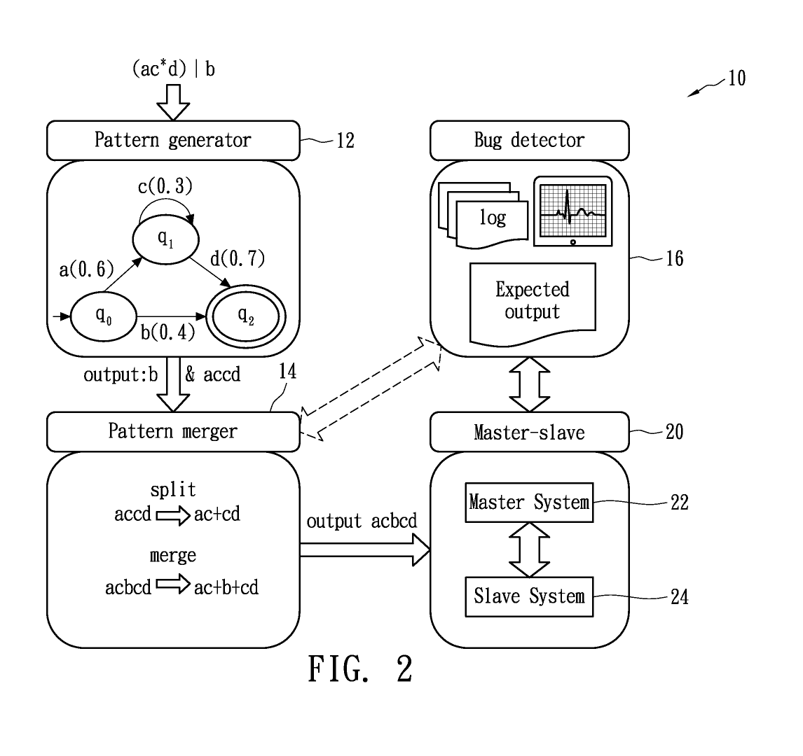

The test tool of the present invention (called “pTest” hereinafter) is designed to execute a stress test on a runtime system running on a specialized processing unit of embedded multicore processors. The pTest runs on a master system to issue a large number of commands for stress testing the runtime behavior of a slave system. FIG. 2 shows the software architecture 10 of pTest, including a pattern generator 12, a pattern merger 14 and a bug detector 16. A master-slave system 20 including a master system 22 and a slave system 24 receives the output of the pattern merger 14 and communicates with the bug detector 16.

The pattern generator 12 serves to produce test patterns by running a PFA. For example, it interprets the regular expression (ac*d)|b and probability distributions to construct the corresponding PFA as shown in FIG. 1. The knowledge about the probability distributions is forwarded to the pattern generator 12 in advance. Both the regular expression and the corresponding PFA recognize the same pattern that is a sequence of the slave system services arranged in rational order. Each test pattern represents a set of the possible slave system services associated to a process of the slave system 24. By running the PFA shown in FIG. 1, instances of generated test patterns from q₀ state to q₂ state are “b” and “accd”.

Because each process in the slave system 24 is controlled by the remote processes in the master system 22, the process execution order in the master system 22 affects the process execution order in the slave system 24. To simulate the concurrent execution in the master-slave system 20, the pattern merger 14 extracts subsequences from each test pattern produced by the pattern generator 12 and then systematically merges all subsequences into one final interleaved test pattern. The work of the pattern merger 14 is to generate the interleaved test patterns and is similar to a process scheduler. In this embodiment, the test pattern “accd” is split into “ac”+“cd”, and then “b” is merged in “accd” to generate an interleaved test pattern “acbcd.” The interleaved test pattern “acbcd” is transmitted to the master-slave system 20 as a basis for testing.

The bug detector 16 tracks the progress of test activities in the master-slave system 20 until it detects the potential system failures and then terminates the test activity that caused these failures. The execution records of each test activity including the state of a process of the slave system 24 and the execution status of committed commands are reserved by the master system 20 and the slave system 24. When potential system failures have been detected, the bug detector 16 dumps the related information to help users reproduce the bugs. The bug detector 16 can communicate with the pattern merger 14 to adjust the interleaved test pattern at runtime.

Given the above, the test method for a master-slave system running on a multicore processor includes the steps of establishing a PFA for a given regular expression; generating test patterns by running the PFA; splitting and merging the test patterns to generate an interleaved test pattern; and performing test on a master-slave system according to the interleaved test pattern. Preferably, the test method further includes a step of debugging failures of a master-slave system during testing.

Each processing core in a multicore processor is connected by the on-chip communication network. The common inter-processor communication mechanisms adopted in such processors are processors polling events through shared memory and sending events by triggering interrupts. The master-slave system 20 implements the software communication infrastructure based on such communication mechanisms to exchange messages between the master cores and slave cores. The pTest can use a native communication library to link the master system 22 and slave system 24 across cores. According to a given regular expression and configuration parameters, pTest automatically generates the adaptive test pattern to the master system 22. The master system 22 issues the remote commands for the slave system 24 through the software communication infrastructure to start the testing work.

A real testing case is exemplified to demonstrate the usage of pTest. The PFA of pCore is applied to pTest, where pCore is a slave operating system designed for specialized processing units, such as a VLIW DSP processor, of an embedded multicore processor. The basic execution unit in pCore is a task referring to a thread in the IEEE POSIX standard. pCore supports up to 16 concurrent tasks on the specialized processing unit. Each task is typically forked with a unique priority by a thread in Linux, a kind of master system running on a main processing unit, to perform stub functions. pCore provides a preemptive priority-based scheduling policy that always schedules the task with highest priority to run. Two main features in the development of pCore are providing efficient kernel services with tiny kernel size and supporting dual-core/multicore communication protocols.

TABLE 1

| Services | Abbreviation of Services | Description |
|---|---|---|
| Task_create | TC | Create a task |
| Task_delete | TD | Delete a task |
| Task_suspend | TS | Suspend a task |
| Task_resume | TR | Resume a task |
| Task_chanprio | TCH | Change the priority of a |
| | | task |
| Task_yield | TY | Terminate the current |
| | | running task |

Table 1 lists the related kernel services provided by pCore for task management. The services contains all the possible events affecting the execution state of a task, thread, or process. In the development of concurrent programs under the master-slave model of this embodiment, each task in pCore is controlled by the corresponding remote thread in Linux. There is a one-to-one correspondence between tasks in pCore and threads in Linux. By surveying the activities of tasks in pCore, the regular expression REGEX describing the behavior of tasks can be modeled as:

REGEX=TC((TCH)*|TSTR(TCH)*)*(TD$|TY$).

Task creation is the initial state during the life cycle of a task. After a task is created with a unique priority, the rest of the task operations including priority change, suspending task, resuming task and task termination can be performed in a legal execution order. For example, the task resuming operation can be performed only while the corresponding task is suspended.

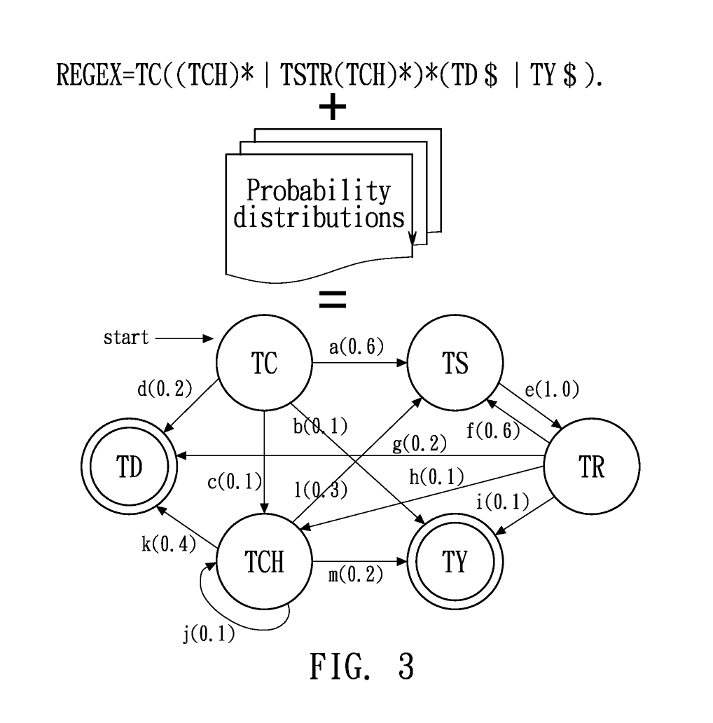

pTest interprets the above regular expression and the given probability distributions to construct the corresponding PFA as shown in FIG. 3. The PFA is a finite-state automaton comprising the services with probability distributions therebetween. The probability distributions were obtained through our experiences in developing concurrent programs under the master-slave model for pCore on embedded multicore processor. The pattern generator of pTest runs the PFA of pCore to produce the test patterns for the pattern merger of pTest. The test patterns are used to verify if pCore would meet the demand for task services.

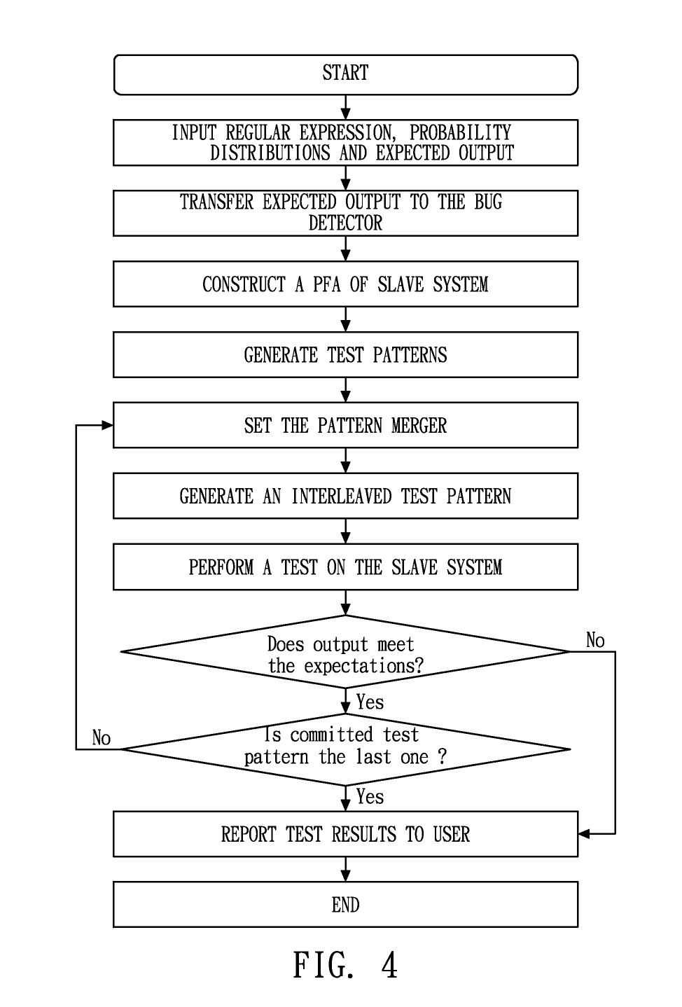

In view of the above, a flow of the test tool running on a master system can be summarized as shown in FIG. 4. In this embodiment, the testing flow includes the steps of inputting regular expression, probability distribution and expected output; transferring expected output to the bug detector; constructing a PFA of slave system; generating test patterns; setting the pattern merger; generating an interleaved test pattern; performing a test on the slave system; reporting test results to the user if the output does not meet the expectations; and reporting the test results to the user if the output meets the expectations and the committed test pattern is the last one; otherwise, repeating the steps from the step of setting the pattern merger.

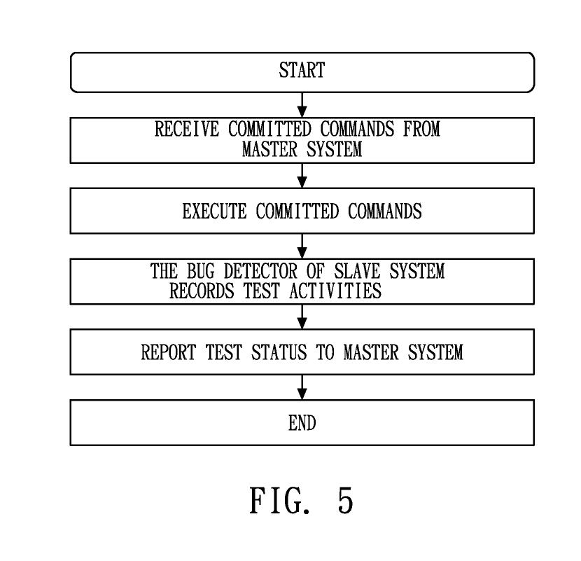

The testing flow running on the slave system, i.e., the step of performing a test on the slave system in FIG. 4, is shown in FIG. 5, including the steps of receiving committed commands from the master system; executing the committed commands, recording test activities by the bug detector of the slave system; and reporting the test status to the master system.

In accordance with this invention, the software testing tool, called pTest, for a master-slave system running on a multicore processor performs a stress test on a slave system for verifying the correctness of services provided by the slave system and detecting the synchronization anomalies or failures of concurrent processes of the master-slave system. The pattern generator of pTest constructs a PFA from the probability distributions and the regular expression provided by testers. A PFA is used to describe the slave system services and generate each test pattern as a set of the slave system services arranged in rational order. A PFA provides the quantitative, probabilistic information to resolve nondeterministic choices about which elements to be included in the test patterns. The test pattern generation and commitment include three steps. First, the pattern generator of pTest automatically generates adaptive test patterns from a PFA. Second, the pattern merger of pTest splits and merges test patterns to generate an interleaved test pattern. Finally, according to an interleaved test pattern, a committer on a master system automatically issues remote commands to test a slave system at runtime. To precisely construct the PFA, the probability distributions are forwarded to the pattern generator of pTest. The bug detector of pTest monitors the execution status of test activities and the state of processes in master-slave systems. When the slave system crashes or faults are detected, the bug detector of pTest terminates the current job and helps users reproduce the bugs.

The above is exemplified by a master system to a slave system. Nevertheless, the present invention can be applied for a master system to a plurality of slave systems, or a plurality of master systems to a plurality of slave systems.

The above-described embodiments of the present invention are intended to be illustrative only. Numerous alternative embodiments may be devised by those skilled in the art without departing from the scope of the following claims.

What is claimed is:

1. A test method for a master-slave system running on a multicore processor, comprising the steps of:
establishing a probabilistic finite automata (FPA) for a given regular expression;
generating test patterns by running the PFA;
splitting and merging the test patterns to generate an interleaved test pattern; and
performing test on the master-slave system according to the interleaved test pattern.

2. The test method of claim 1, further comprising a step of debugging failures of the master-slave system during testing.

3. The test method of claim 1, wherein the step of performing test on the master-slave system comprises a stress test on the slave system for verifying correctness of services provided by the slave system and detecting the synchronization failures of concurrent processes.

4. The test method of claim 1, wherein the PFA is defined as a finite-state automaton with only state transition probabilities and a state in the PFA is modeled as a service of a slave system.

5. The test method of claim 1, wherein the given regular expression describes the behaviors of services of the slave system.

6. The test method of claim 5, wherein the services contains all the possible events affecting the execution state of a task, thread, or process.

7. The test method of claim 1, wherein each of the test patterns comprises services of the slave system arranged in a rational order.

8. A test tool for a master-slave system running on a multicore processor, comprising:
a pattern generator configured to generate test patterns by running a probabilistic finite automaton (PFA) for a given regular expression;
a pattern merger configured to split and merge the test patterns to generate an interleaved test pattern; and
a bug detector configured to debug failures of the master-slave system while performing test on the master-slave system according to the interleaved test pattern.

9. The test tool of claim 8, wherein testing the master-slave system comprises a stress test on the slave system for verifying correctness of services provided by the slave system and detecting the synchronization failures of concurrent processes.

10. The test tool of claim 8, wherein the regular expression describes the behaviors of services of the slave system.

11. The test tool of claim 10, wherein the services contains all the possible events affecting the execution state of a task, thread, or process.

12. The test tool of claim 8, wherein the PFA is defined as a finite-state automaton with only state transition probabilities and a state in the PFA is modeled as a service of a slave system.

13. The test tool of claim 8, wherein each of the test pattern comprises services of the slave system arranged in a rational order.
